(19) United States
(12) Patent Application Publication
(10) Pub. No.: US 2015/0367786 A1
(43) Pub. Date: Dec. 24, 2015

(54) FIXING DEVICE FOR FIXING A VEHICLE ELECTRONIC DEVICE TO A DASHBOARD

(71) Applicant: E-LEAD ELECTRONIC CO., LTD., Changhua (TW)

(72) Inventor: STEPHEN CHEN, Changhua (TW)

(21) Appl. No.: 14/307,504

(22) Filed: Jun. 18, 2014

(51) Int. Cl. B60R 11/02

(52) U.S. Cl. CPC B60R 11/02; B60R 2011/0005

(57) ABSTRACT

A fixing device for fixing a vehicle electronic device to a dashboard includes an adhesive portion, a fixing portion and a foldable portion. The adhesive portion is fixed to the windshield by an adhesive member. The fixing portion is placed on the dashboard and includes a top surface and an opposite bottom surface, and on the top surface is provided a protruding engaging member. The foldable portion is disposed between the adhesive portion and the fixing portion, and the adhesive portion is connected to the fixing portion by the foldable portion. The fixing device is adhered to the windshield, so there is no glue left on the plastic dashboard. The vehicle electronic device is attached to the fixing device by magnetic attraction or concave-convex engagement, so that the vehicle electronic device can be easily assembled to or disassembled from the fixing device.

### BACKGROUND OF THE INVENTION

### Field of the Invention

The present invention relates to a vehicle electronic device to a dashboard, and more particularly to a fixing device for fixing a vehicle electronic device to a dashboard.

### DESCRIPTION OF THE PRIOR ART

With the advancement of science and technology, many vehicle electronic devices which are put on the dashboard to provide related running data of the vehicle or surrounding data for the driver's reference have been developed. As shown in FIG. 1, a head up display device 10 comprises a housing 11, a display module 12 and a transparent cover 13. The housing 11 is fixed to the dashboard of a vehicle, and the display module 12 projects images onto the transparent cover 13, so as to form a vehicle electronic device which enables the driver to read vehicle information, including traffic and travel information, without looking down, thus improving driving safety.

The existing method for fixing the vehicle electronic device is to apply glue or put an antiskid pad between the electronic device and the dashboard. However, the dashboard has unequal curvature and is usually made of plastic, if the vehicle electronic device is fixed to the dashboard by glue, the glue is likely to be left on the plastic dashboard and difficult to clean off. Furthermore, the vehicle electronic device is difficult to remove once it is glued to the dashboard, and becomes a target of theft. Using antiskid pad to fixing the vehicle electronic device also has its own problem that the vehicle electronic device is likely to slide or fall off, in case of an emergency brake or a car collision.

The present invention has arisen to mitigate and/or obviate the afore-described disadvantages.

### SUMMARY OF THE INVENTION

The primary objective of the present invention is to provide a fixing device for fixing a vehicle electronic device to a dashboard. The fixing device is adhered to the windshield, so there is no glue left on the plastic dashboard. The vehicle electronic device is attached to the fixing device by means of magnetic attraction, concave-convex engagement or other means, so that the vehicle electronic device can be easily assembled to or disassembled from the fixing device, and won't become a target of theft.

To achieve the above objective, a fixing device for fixing a vehicle electronic device to a dashboard is disposed between a windshield and the dashboard and comprises: an adhesive portion fixed to the windshield by an adhesive member; a fixing portion placed on the dashboard and including a top surface and an opposite bottom surface, on the top surface being provided a protruding engaging member; and a foldable portion disposed between the adhesive portion and the fixing portion, and the adhesive portion being connected to the fixing portion by the foldable portion in a manner that an angle is defined between the adhesive portion and the fixing portion.

Preferably, at least one engaging hole for engaging with the protruding engaging member of the fixing device is formed at a bottom of the base that comes into contact with the fixing device, so as to fix the vehicle electronic device to the fixing device. A first magnetic member is disposed at a bottom of the vehicle electronic device that comes into contact with the fixing device, and at the top surface of the fixing portion is provided a second magnetic member, so that the vehicle electronic device and the fixing device are fixed to each other by the magnetic attraction of the first and second magnetic members.

Preferably, the foldable portion, the adhesive portion, the fixing portion are an integral structure in the form of a bent flexible plate, or the foldable portion is a pivot member, or the foldable portion is a pivot slot, the adhesive portion is fixed to the windshield, and the angle between the adhesive portion and the fixing portion is adjustable through pivoting of the foldable portion.

Preferably, the fixing device is provided with a first antiskid pad at the bottom surface of the fixing portion, and at the top surface of the fixing portion of the fixing device is further provided a second antiskid pad.

### BRIEF DESCRIPTION OF THE DRAWINGS

FIG. 1 shows a conventional head up display device;

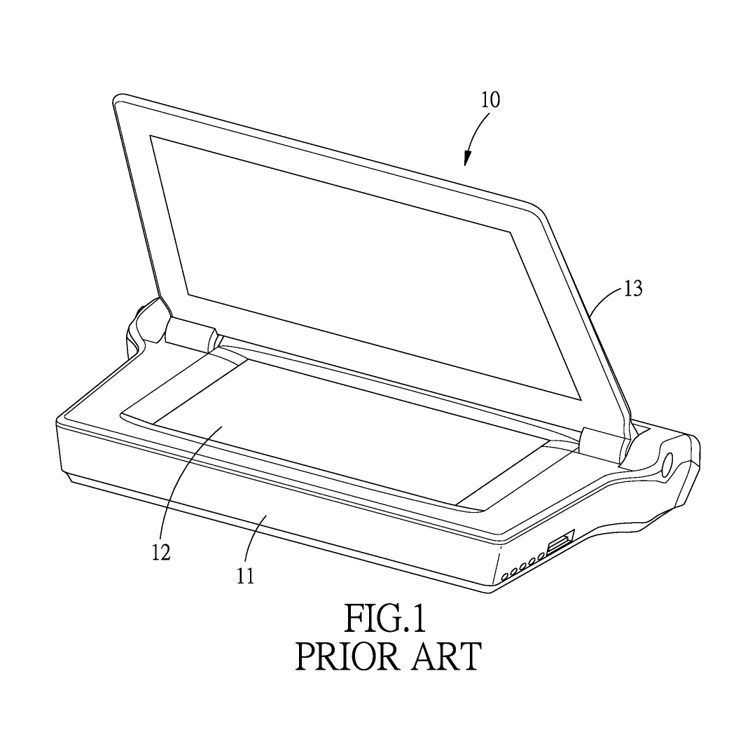

FIG. 2 shows that a fixing device in accordance with the present invention is used in combination with a vehicle electronic device;

FIG. 3 shows the fixing device for fixing the vehicle electronic device to a dashboard in accordance with the present invention;

FIG. 4 shows the bottom of the vehicle electronic device in accordance with the present invention;

FIG. 5 is a cross sectional view of the assembly of the fixing device and the vehicle electronic device in accordance with the present invention; and

FIG. 6 is a cross sectional view showing that the vehicle electronic device is fixed to the windshield by the fixing device in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

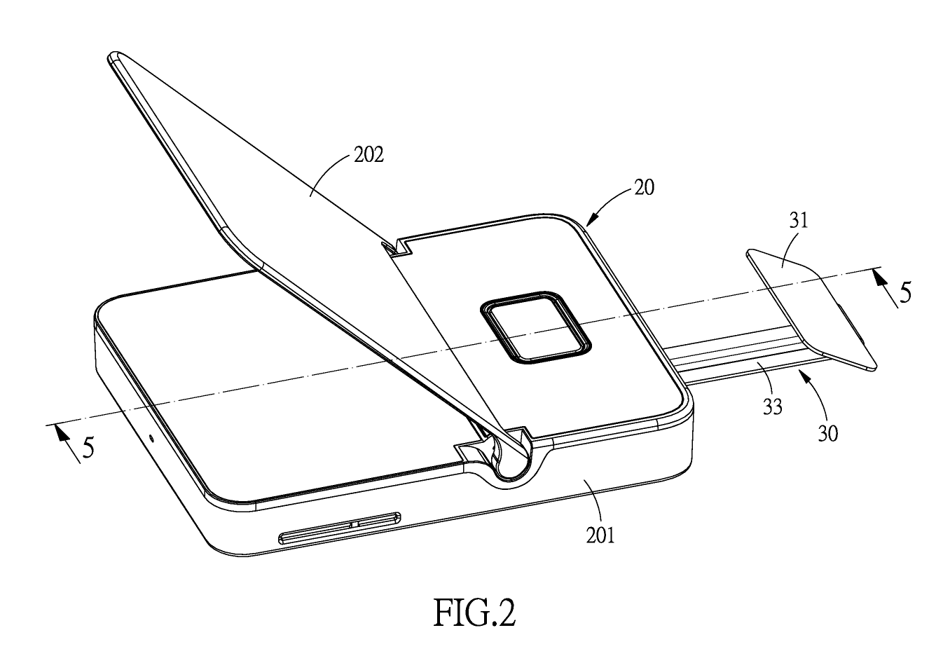

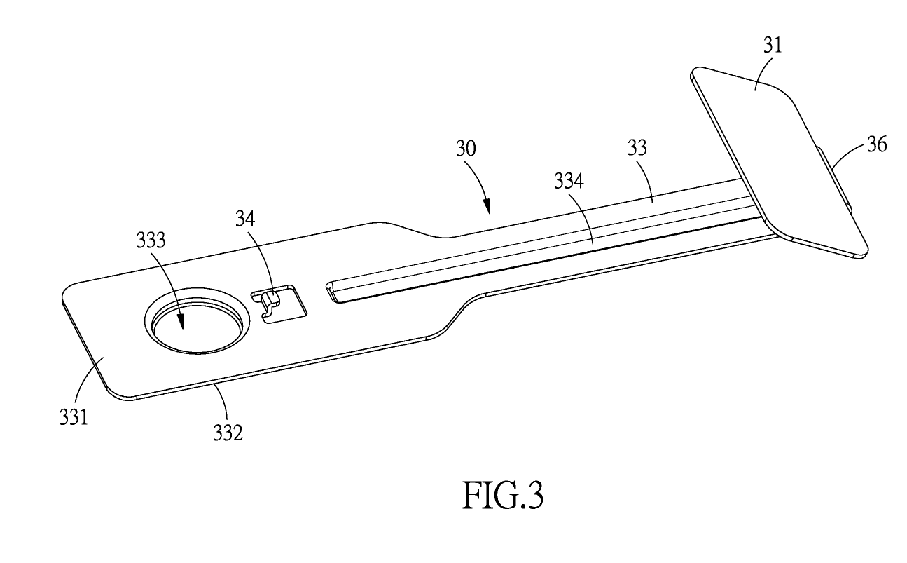

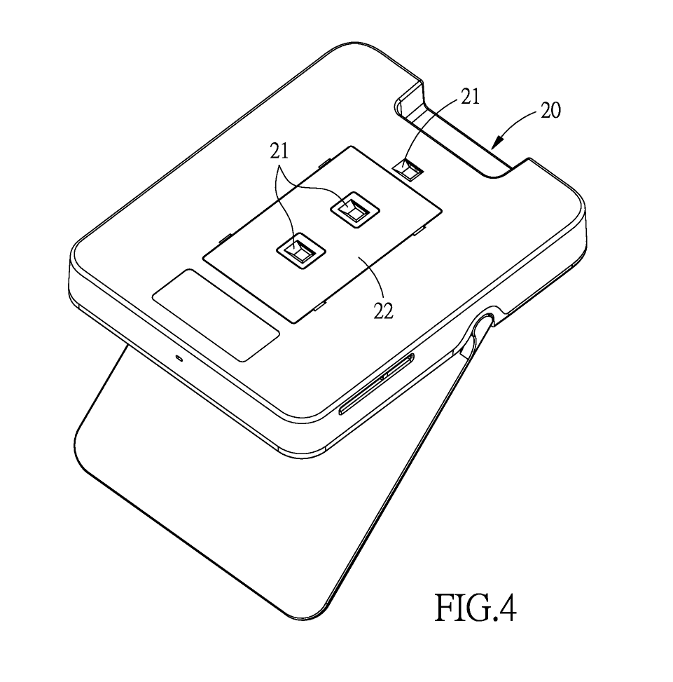

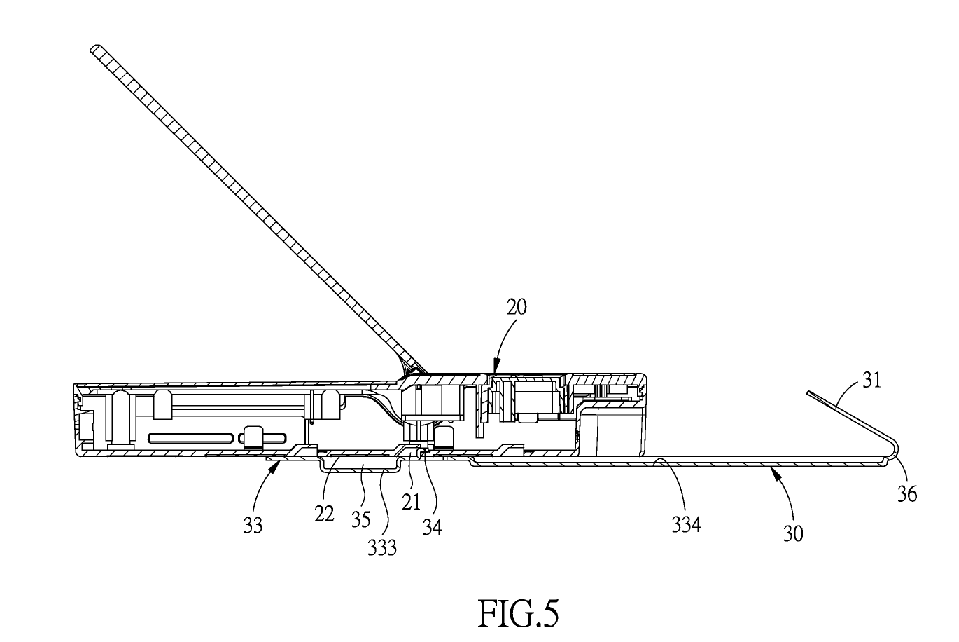

Referring to FIGS. 2-6, a fixing device 30 for fixing a vehicle electronic device 20 to a dashboard B in accordance with the present invention is disposed between a windshield A and the dashboard B. The fixing device 30 is a one-piece bent plate which is integrally formed with an adhesive portion 31, a fixing portion 33 and a foldable portion 36 between the adhesive portion 31 and the fixing portion 33. The adhesive portion 31 is provided with an adhesive member 32 to be fixed to the windshield A. To improve the bonding between the adhesive portion 31 and the windshield A, the adhesive portion 31 is rectangular shaped, but is not limited to the rectangular shape and can be in any shapes as long as it facilitates the adhering of the adhesive portion 31 to the windshield A. The adhesive member 32 can be double side adhesive tape, glue or another adhesive material which can be used to adhere the adhesive portion 31 to windshield A.

The fixing portion 33 is an elongated plate extending from the foldable portion 36 and placed on the dashboard B for fixing of the vehicle electronic device 20. The fixing portion 33 includes a top surface 331 and an opposite bottom surface 332. On the top surface 331 are provided a protruding engaging member 34, a receiving recess 333 at one side of the engaging member 34, and a reinforced rib 334 which is located at another side of the engaging member 34 and disposed between the engaging member 34 and the foldable portion 36 to reinforce the structure strength of the fixing device 30.

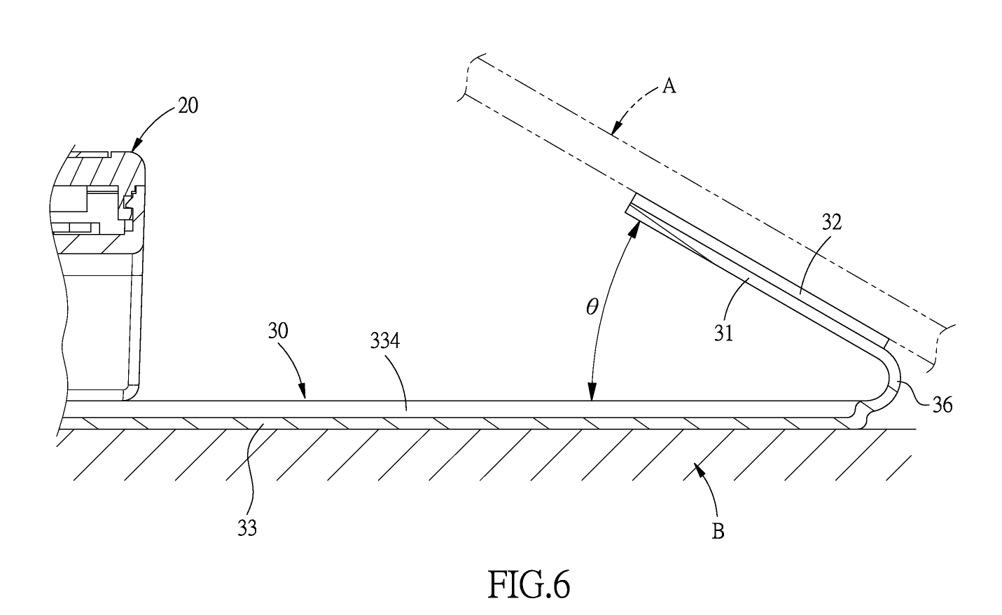

Referring then to FIG. 6, the foldable portion 36 is a flexible structure integral with the adhesive portion 31 and the fixing portion 33, and can be a plate made of metal or other flexible materials. Through folding of the foldable portion 36, the adhesive portion 31 is fixed to the windshield A. Or, the foldable portion 36 can also be a pivot member independent from the adhesive portion 31 and the fixing portion 33, and at the end of the adhesive portion 31 and the fixing portion 33 is formed an inserting structure for pivotally insertion of the pivot member. Or, the foldable portion 36 can be a pivot slot formed at the end of the adhesive portion 31 and the fixing portion 33, so that the angle θ of the adhesive portion 31 with respect to the fixing portion 33 can be adjusted through pivoting of the foldable portion 36, allowing the fixing device 30 to be adjusted to fit the angle between the windshield A and the dashboard B of different vehicles.

What mentioned above are the structures of the embodiment of the present invention, for a better understanding of the fixing device 30 for fixing the vehicle electronic device 20 to the dashboard B in accordance with the present invention, its operating advantages and the specific objects attained by its uses, reference should be had to the following descriptive matter.

Referring then to FIGS. 2-6, the vehicle electronic device 20 includes a base 201 and a cover 202 for displaying images. At the bottom of the base 201 that comes into contact with the fixing device 30 is provided at least one engaging hole 21 for engaging with the engaging member 34 of the fixing device 30, so as to fix the vehicle electronic device 20 to the fixing device 30. In this embodiment, the vehicle electronic device 20 is provided with three engaging holes 21 for adjusting the position of the vehicle electronic device 20 on the dashboard B to meet different driver's demands.

The fixing device 30 can further be provided with magnetic attracting structure which is disposed between the fixing device 30 and the vehicle electronic device 20 to enhance the bonding therebetween. As shown in FIGS. 2-5, a first magnetic member 22 is disposed at the bottom of the vehicle electronic device 20 that comes into contact with the fixing device 30. At the top surface 331 of the fixing portion 33 is provided a second magnetic member 35, so that the vehicle electronic device 20 and the fixing device 30 are fixed to each other by the magnetic attraction of the first and second magnetic members 22, 35. In this embodiment, the second magnetic member 35 is a magnetic iron, and the receiving recess 333 for holding the second magnetic member 35 is formed at the top surface 331 of the fixing portion 33 of the fixing device 30, and the first magnetic member 22 is a metal piece which can be attracted by the magnetic iron and is disposed at the bottom of the receiving recess 333. The first and second magnetic members 22, 35 can both be magnetic irons.

The fixing device 30 can be provided with a first antiskid pad 37 at the bottom surface 332 of the fixing portion 33 to enable the fixing device 30 to be positioned on the dashboard B more firmly without using adhesive. At the top surface 331 of the fixing portion 33 of the fixing device 30 is further provided a second antiskid pad 38 to improve stability of positioning the vehicle electronic device 20 on the fixing device 30, preventing displacement of the vehicle electronic device 20 with respect to the dashboard B.

While we have shown and described various embodiments in accordance with the present invention, it is clear to those skilled in the art that further embodiments may be made without departing from the scope of the present invention.

What is claimed is:

1. A fixing device for fixing a vehicle electronic device to a dashboard being disposed between a windshield and the dashboard, comprising:
an adhesive portion fixed to the windshield by an adhesive member;
a fixing portion placed on the dashboard and including a top surface and an opposite bottom surface, on the top surface being provided a protruding engaging member; and
a foldable portion disposed between the adhesive portion and the fixing portion, and the adhesive portion being connected to the fixing portion by the foldable portion in a manner that an angle is defined between the adhesive portion and the fixing portion.

2. The fixing device for fixing the vehicle electronic device to the dashboard as claimed in claim 1, wherein at least one engaging hole for engaging with the protruding engaging member of the fixing device is formed at a bottom of the base that comes into contact with the fixing device, so as to fix the vehicle electronic device to the fixing device.

3. The fixing device for fixing the vehicle electronic device to the dashboard as claimed in claim 1, wherein a first magnetic member is disposed at a bottom of the vehicle electronic device that comes into contact with the fixing device, and at the top surface of the fixing portion is provided a second magnetic member, so that the vehicle electronic device and the fixing device are fixed to each other by the magnetic attraction of the first and second magnetic members.

4. The fixing device for fixing the vehicle electronic device to the dashboard as claimed in claim 3, wherein the second magnetic member is a magnetic iron, and a receiving recess for holding the second magnetic member is formed at the top surface of the fixing portion of the fixing device, and the first magnetic member is a metal piece which can be attracted by the magnetic iron and is disposed at a bottom of the receiving recess.

5. The fixing device for fixing the vehicle electronic device to the dashboard as claimed in claim 1, wherein the adhesive member is double side adhesive tape or glue.

6. The fixing device for fixing the vehicle electronic device to the dashboard as claimed in claim 1, wherein the foldable portion, the adhesive portion, the fixing portion are an integral structure in the form of a bent flexible plate, and through folding of the foldable portion, the adhesive portion is fixed to the windshield.

7. The fixing device for fixing the vehicle electronic device to the dashboard as claimed in claim 1, wherein the foldable portion is a pivot member, the adhesive portion is fixed to the windshield, and the angle between the adhesive portion and the fixing portion is adjustable through pivoting of the foldable portion.

8. The fixing device for fixing the vehicle electronic device to the dashboard as claimed in claim 1, wherein the foldable portion is a pivot slot, the adhesive portion is fixed to the windshield, and the angle between the adhesive portion and the fixing portion is adjustable through pivoting of the foldable portion.

9. The fixing device for fixing the vehicle electronic device to the dashboard as claimed in claim 1, wherein the fixing device is provided with a first antiskid pad at the bottom surface of the fixing portion, and at the top surface of the fixing portion of the fixing device is further provided a second antiskid pad.

10. The fixing device for fixing the vehicle electronic device to the dashboard as claimed in claim 1, wherein the adhesive portion, the fixing portion and the foldable portion are integrally formed into an one-piece bent plate, the adhesive portion is rectangular shaped, the fixing portion is an elongated plate extending from the foldable portion and includes a reinforced rib.
